(19) United States
(12) Patent Application Publication
(10) Pub. No.: US 2018/0047076 A1
(43) Pub. Date: Feb. 15, 2018

(54) SALE SERVICE PROCESS ASSISTANCE

(71) Applicant: Kathlynn Fekete, Astoria, NY (US)

(72) Inventor: Kathlynn Fekete, Astoria, NY (US)

(21) Appl. No.: 15/232,140

(22) Filed: Aug. 9, 2016

(51) Int. Cl. G06Q 30/06; G06Q 10/06; G06Q 30/00

(52) U.S. Cl. CPC G06Q 30/0601; G06Q 30/01; G06Q 10/0633

(57) ABSTRACT

A system and method of assisting a sales service process includes a work flow template associated with one or more aspects of a business proposal screen, a cost analysis template coupled to the work flow template, a savings analysis template providing total savings and a server configured to store and retrieve the work flow, cost analysis and savings analysis templates along with the sales service process data. The work flow, cost analysis and savings analysis templates are configured to be updated based on an iterative process to include feedback about customer needs data.

### FIELD OF TECHNOLOGY

The present invention relates to a method, system and/or apparatus for sale service process assistance.

### BACKGROUND

Selling is considered to be both a science and an art. Selling as a science falls into three general categories. The first general category is scientific research in human communication and how people learn and retain information, psychology, neuroscience, and human achievement. The second general category is processes—identifying the processes to identify qualified prospects, to conduct thorough and accurate customer needs assessments, to effectively engage sales support resources, to develop customer centered solutions, and finally the process to negotiate and close the sale. The third general category is best practices—identifying the best practices of the top sales performers.

Business and government entities often utilize in their operations a number of different applications, implemented using a plurality of computer network resources, linked to a variety of database technologies. For example, Company A may use an email application, a separate customer relationship management (CRM) system, a business management platform, a business intelligence platform, a document management system, a media content manager, and may also subscribe to one or more platforms for managing media content and managing social media campaigns (“business systems”). Typically, the business systems will emanate from a variety of different suppliers.

Sales are a tedious process that may involve sending of proposals back and forth based on data collected from a customer. Sales services are in need of simplification. The applications and processes out there leave a lot to be desired.

### SUMMARY

Disclosed are a method, an apparatus and/or a system of sales service process assistance.

In one aspect, a system of assisting a sales service process includes a work flow template associated with one or more aspects of a business proposal screen, a cost analysis template coupled to the work flow template, a savings analysis template providing total savings and a server configured to store and retrieve the work flow, cost analysis and savings analysis templates along with the sales service process data. The work flow, cost analysis and savings analysis templates are configured to be updated based on an iterative process to include feedback about customer needs data.

In another aspect, a method of assisting a sales service process includes creating, through a mobile application communicatively coupled to a server, one or more of a work flow and cost analysis template and associating, through a mobile application communicatively coupled to a server, the cost analysis template with the work flow template. Further, a savings analysis template based on the work flow template and cost analysis template is generated through a processor communicatively coupled to a server. The method further includes receiving a request at a server for one or more of a work flow, cost analysis and savings analysis templates from one or more of a web application and mobile application. The method also includes configuring the server to store and retrieve the work flow, cost analysis and savings analysis templates and the sales service process data. The work flow, cost analysis and savings analysis templates are configured to be updated based on an iterative process to include feedback about customer needs data.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a system of assisting a sales service process, according to one or more embodiments.

FIG. 2 is a diagrammatic representation of a data processing system capable of processing a set of instructions to perform any one or more of the methodologies herein, according to one embodiment.

FIG. 3 is a process flow diagram detailing the operations of a method of assisting a sales service process, according to one or more embodiments.

FIG. 4 is an example of a proposal, according to one or more embodiments.

FIG. 5 is an example of statement analysis, according to one or more embodiments.

FIG. 6 is a team pipeline view of a mobile application, according to one or more embodiments.

FIG. 7 is a user view of a mobile application, according to one or more embodiments.

FIG. 8 is view of creating or disabling a user account, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of enhancing understandability of code using code clones. Although the present embodiments have been described with reference to specific example embodiments, it will be evident that various modifications and changes may be made to these embodiments without departing from the broader spirit and scope of the various embodiments.

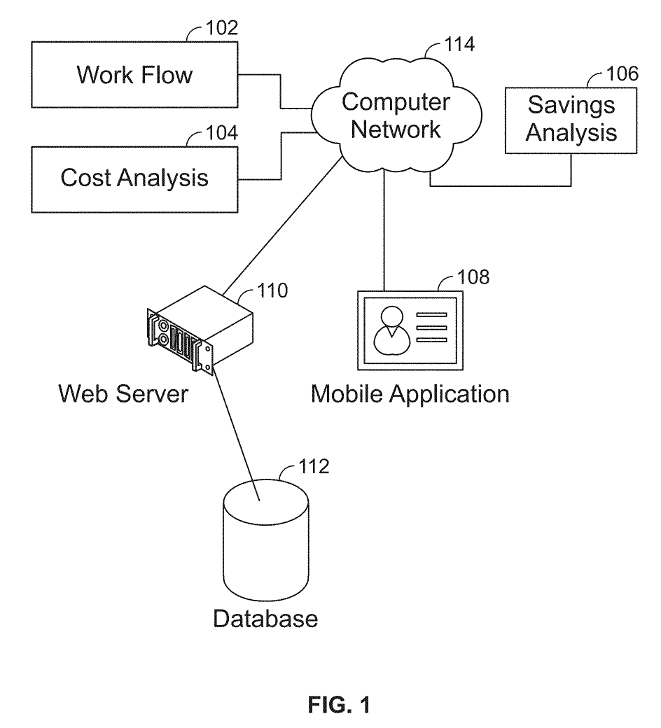

FIG. 1 is a schematic view of a system of assisting a sales service process, according to one or more embodiments.

FIG. 1 is a block diagram detailing components involved in assisting a sales service process, according to one or more embodiments. A system of assisting a sales service process includes a work flow template 102 associated with one or more aspects of a business proposal screen, a cost analysis template 104 coupled to the work flow template, a savings analysis template 106 providing total savings and a server 110 configured to store and retrieve the work flow, cost analysis and savings analysis templates along with the sales service process data. The work flow, cost analysis and savings analysis templates are configured to be updated based on an iterative process to include feedback about customer needs data. The various entities shown in FIG. 1 may be associated with a computer network 114.

The customer needs data may be stored on a database 112. The work flow 102, cost analysis 104 and savings analysis template 106 may be accessed through a mobile application 110.

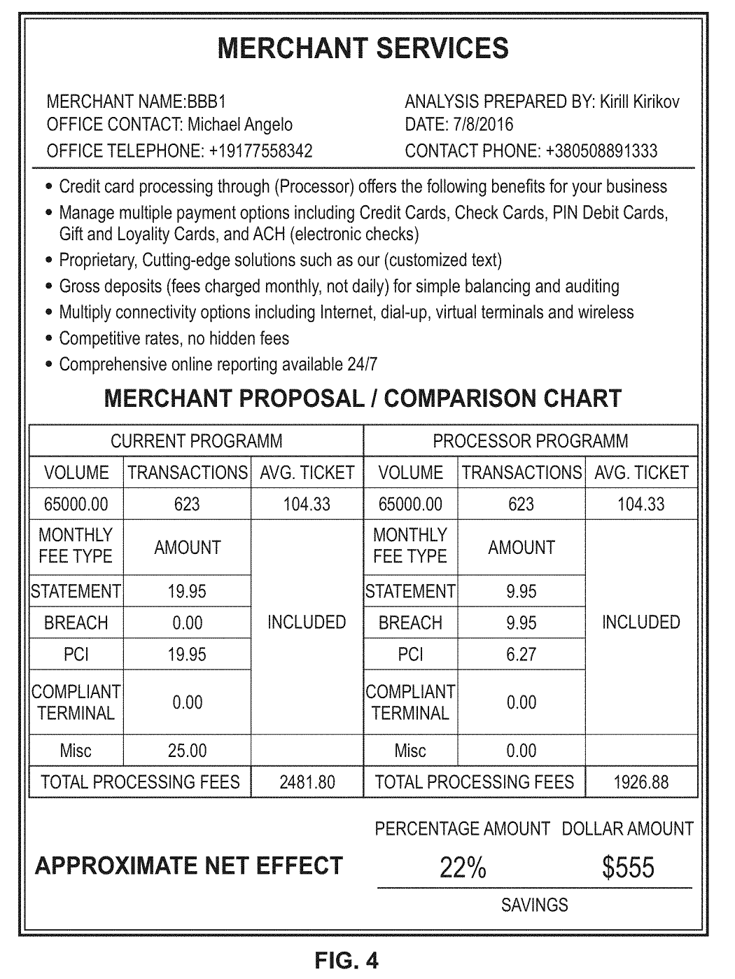

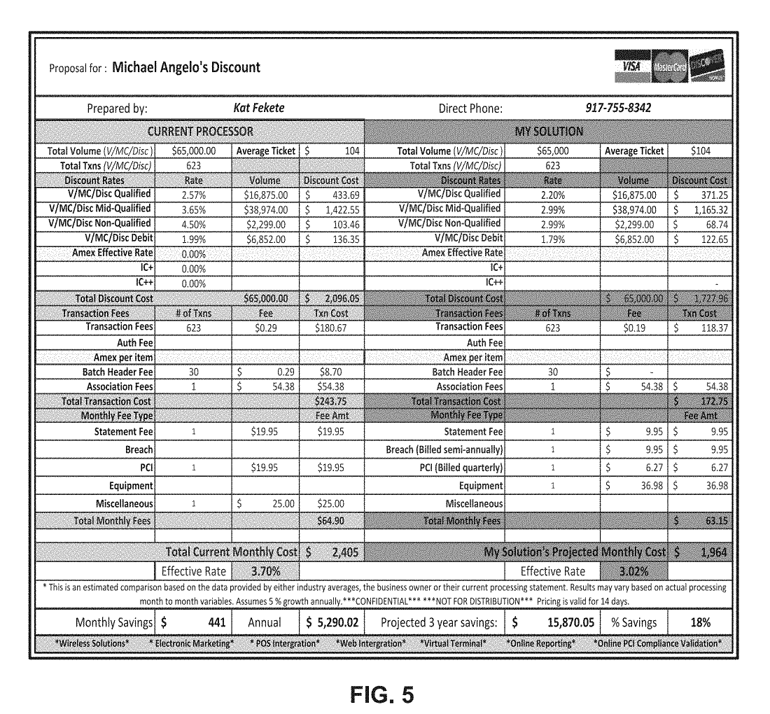

The customer needs data may be associated with one or more of a transaction, volume, fees, interchange and margins as shown in FIG. 4 and FIG. 5. The cost analysis template may include one or more comparison charts as shown in FIG. 5.

The system may be associated with one or more of a multi-tier and Interest Charge pass through data.

The system of claim 1, wherein at least one of the work flow template, cost analysis and savings analysis templates are sent to a customer associated with the sales service process.

The system of claim 1, wherein the system is accessed through at least one of a web application and mobile application.

The mobile application may an Android™ or IOS® application to be downloaded from Google Play store or Apple App Store (iTunes®).

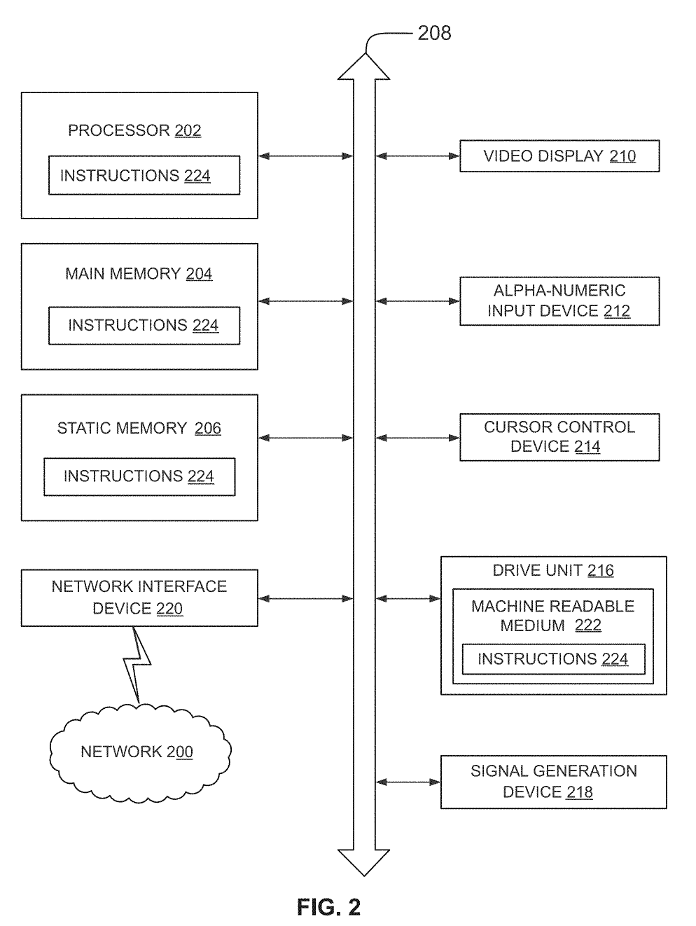

FIG. 2 is a diagrammatic representation of a data processing system capable of processing a set of instructions to perform any one or more of the methodologies herein, according to an example embodiment. FIG. 2 shows a diagrammatic representation of machine in the example form of a computer system 200 within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and or as a peer machine in a peer-to-peer (or distributed) network environment. The machine may be a personal-computer (PC), a tablet PC, a set-top box (STB), a Personal Digital Assistant (PDA), a cellular telephone, a web appliance, a network router, switch and or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 200 includes a processor 202 (e.g., a central processing unit (CPU) a graphics processing unit (GPU) and/or both), a main memory 204 and a static memory 206, which communicate with each other via a bus 208. The computer system 200 may further include a video display unit 210 (e.g., a liquid crystal displays (LCD) and/or a cathode ray tube (CRT)). The computer system 200 also includes an alphanumeric input device 212 (e.g., a keyboard), a cursor control device 214 (e.g., a mouse), a disk drive unit 216, a signal generation device 218 (e.g., a speaker) and a network interface device 220.

The disk drive unit 216 includes a machine-readable medium 222 on which is stored one or more sets of instructions 224 (e.g., software) embodying any one or more of the methodologies and/or functions described herein. The instructions 224 may also reside, completely and/or at least partially, within the main memory 204 and/or within the processor 202 during execution thereof by the computer system 200, the main memory 204 and the processor 202 also constituting machine-readable media.

The instructions 224 may further be transmitted and/or received over a network 226 via the network interface device 220. While the machine-readable medium 222 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

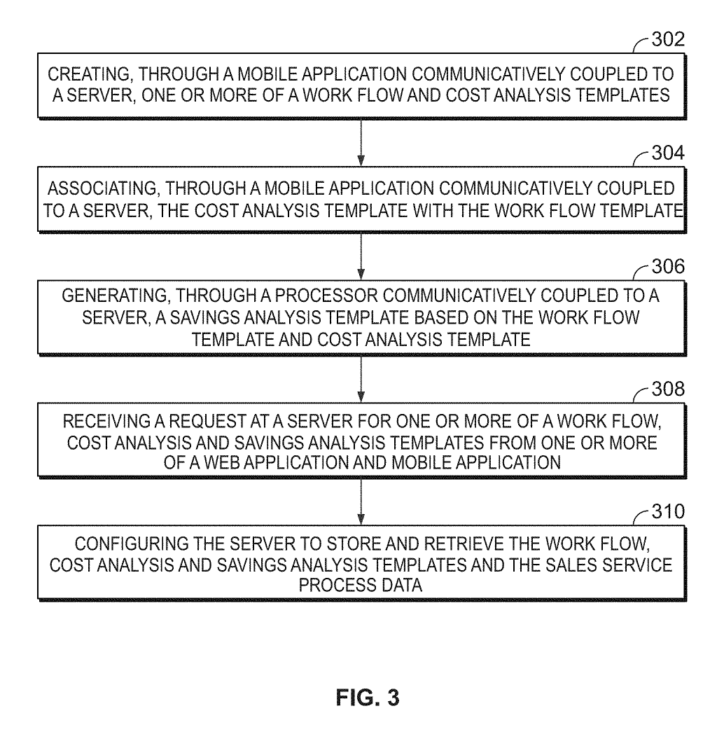

FIG. 3 is a process flow diagram detailing the operations of a method of assisting a sales service process, according to one or more embodiments.

In one or more embodiments, a method of assisting a sales service process includes creating, through a mobile application communicatively coupled to a server, one or more of a work flow and cost analysis template 302 and associating, through a mobile application communicatively coupled to a server, the cost analysis template with the work flow template 304. Further, a savings analysis template based on the work flow template and cost analysis template is generated through a processor communicatively coupled to a server 306. The method further includes receiving a request at a server for one or more of a work flow, cost analysis and savings analysis templates from one or more of a web application and mobile application 308. The method also includes configuring the server to store and retrieve the work flow, cost analysis and savings analysis templates and the sales service process data 310. The work flow, cost analysis and savings analysis templates are configured to be updated based on an iterative process to include feedback about customer needs data.

In one or more embodiments, the customer needs data may be associated with one or more of a transaction, volume, fees, interchange and margins. The cost analysis template may include one or more comparison charts. The sales service process may be associated with one of a multi-tier and IC pass through data.

In one or more embodiments, one or more of the work flow template, cost analysis and savings analysis templates may be sent to a customer associated with the sales service process.

FIG. 4 is an example of a proposal, according to one or more embodiments.

FIG. 5 is an example of statement analysis, according to one or more embodiments.

The comparison charts shown in FIGS. 4 and 5 provide with a comparison of the strengths and weaknesses of an offering against competitive alternatives. The competitive landscape is also used to create quality selling information in the communication process.

The competitive landscape presented as a comparison allows the customer to decide based on various metrics that may be specific to the customer's requirements. The comparison may also allow for a total savings that the customer achieves by buying. The comparison may along multiples systems and alternatives that the customer chooses from. Further, the proposal of FIG. 4 and statement analysis of FIG. 5 may be sent to a customer. Communication with the customer may be over email. Email may be automatically generated through a mobile application. The mobile application may allow for accessing various templates such as work flow, cost analysis and savings analysis.

In one or more embodiments, customer data and requirements may be collected through one or more of a web application, mobile application, and conversation with a customer. An analysis of the customer requirement may be emailed to the customer along with possible savings and other advantages.

In one or more embodiments, a web based or mobile application may be tailored to assist Merchant Service Sales professionals in completing a professional statement cost analysis for prospects as part of a sales process. The application may streamline proposal preparing process from hours to minutes and shorten the sale process by facilitating a one-call close. The application may also allow the Sales Professional to display the results, in a professional template, on their phone or tablet, as well as, email it to the prospects preferred email address.

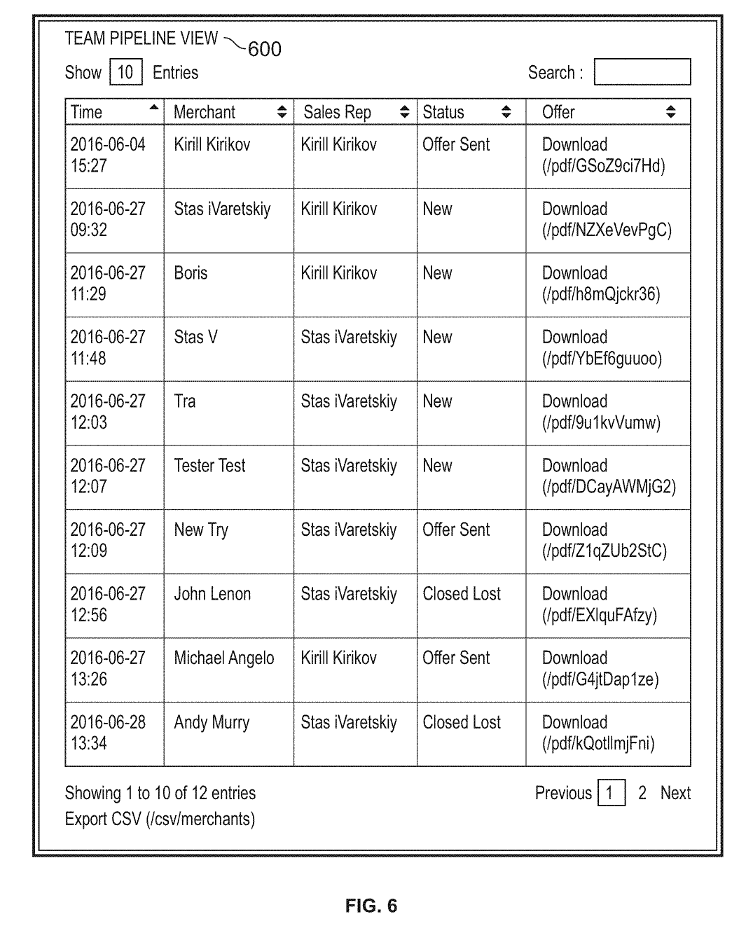

FIG. 6 is a team pipeline view of a mobile application or a web application, according to one or more embodiments. In one or more embodiments, FIG. 6 may be an admin view. FIG. 6 is a team pipeline view 600 associated with a mobile application or web application. A sales pipeline may be tracked through the mobile application as shown in FIG. 6.

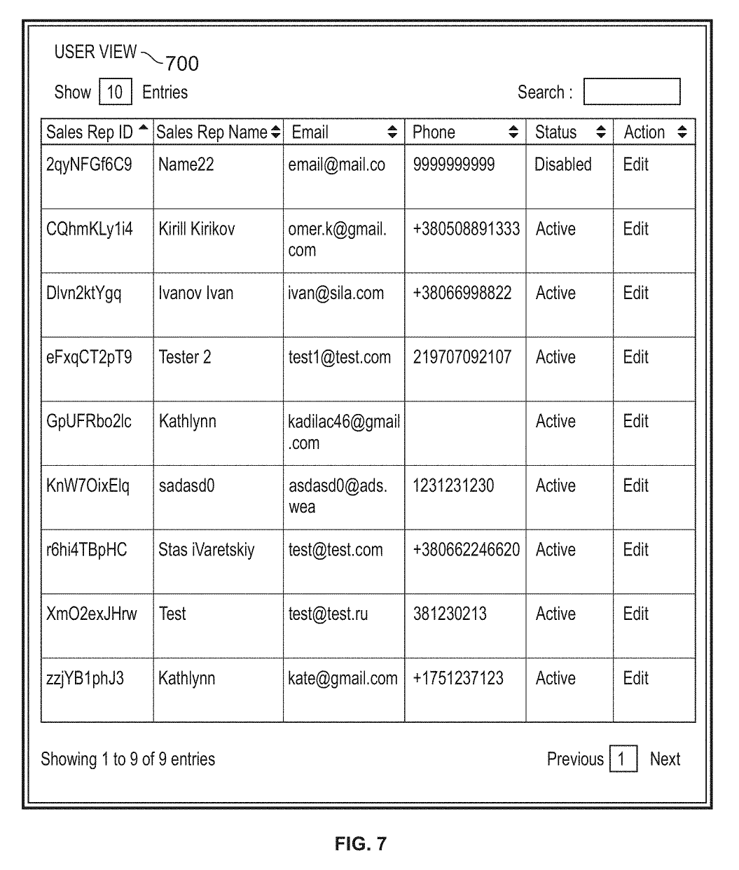

FIG. 7 is a user view of a mobile application or a web application, according to one or more embodiments. In one or more embodiments, FIG. 7 may be an admin view. User view 700 may be associated with a view of a sale service process assistance in a mobile application or a web application. In the admin view of user view 700, the user may track sales representatives and various sales prospects and completed sales associated with the sale representatives. Further, specific details associated with the sales representatives may be viewed through the admin view.

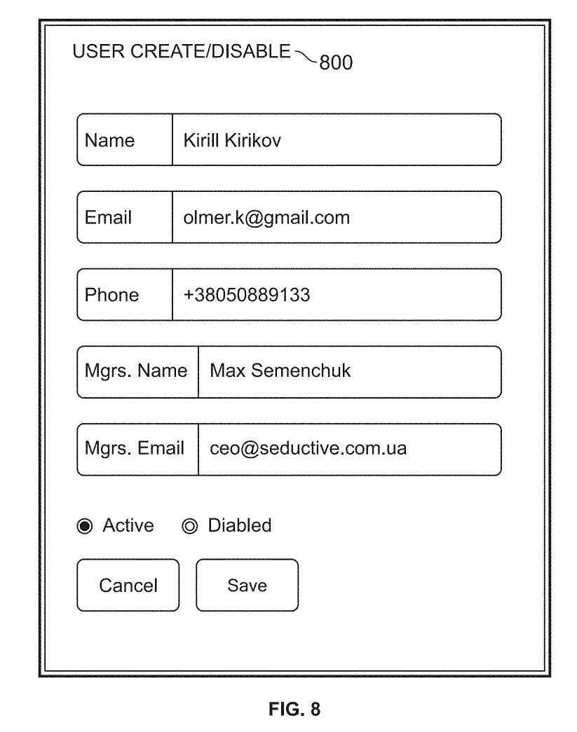

FIG. 8 is view of creating or disabling a user account, according to one or more embodiments. In one or more embodiments, FIG. 8 may be an admin view wherein a new user may be added to a database of users. The users may be associated with a mobile application or a web application for sale service process assistance. FIG. 8 is associated with user create and disable 800 of user account creation in a sale service process assistance.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-Ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What is claimed is:

1. A system of assisting a sales service process, the system comprising:
A work flow template associated with at least one aspect of a business proposal screen;
a cost analysis template coupled to the work flow template, the cost analysis template including at least one of the aspects from the work flow template;
a savings analysis template providing total savings in at least one of a percentage measure and figure measure; and
a server configured to store and retrieve the work flow, cost analysis and savings analysis templates and the sales service process data, where the work flow, cost analysis and savings analysis templates are configured to be updated based on an iterative process to include feedback about customer needs data.

2. The system of claim 1, wherein the customer needs data is associated with at least one of transactions, volume, fees, interchange and margins.

3. The system of claim 1, wherein cost analysis template includes at least one comparison chart.

4. The system of claim 1, wherein the system is associated with at least one of a multi-ties and IC pass through data.

5. The system of claim 1, wherein at least one of the work flow template, cost analysis and savings analysis templates are sent to a customer associated with the sales service process.

6. The system of claim 1, wherein the system is accessed through at least one of a web application and mobile application.

7. A method of assisting a sales service process, the method comprising:
creating, through a mobile application communicatively coupled to a server, at least
one of a work flow and cost analysis template;
associating, through a mobile application communicatively coupled to a server, the
cost analysis template with the work flow template;
generating, through a processor communicatively coupled to a server, a saving s analysis template based on the work flow template and cost analysis template;
receiving a request at a server for at least one of a work flow, cost analysis and savings analysis templates from at least one of a web application and mobile application; and
configuring the server to store and retrieve the work flow, cost analysis and savings
analysis templates and the sales service process data,
wherein the work flow, cost analysis and savings analysis templates are configured to be updated based on an iterative process to include feedback about customer needs data.

8. The method of claim 7, wherein the customer needs data is associated with at least one of transactions, volume, fees, interchange and margins.

9. The method of claim 7, wherein cost analysis template includes at least one comparison chart.

10. The method of claim 7, wherein the sales service process is associated with at least one of a multi-tier and IC pass through data.

11. The method of claim 7, wherein at least one of the work flow template, cost analysis and savings analysis templates are sent to a customer associated with the sales service process.
